(19) United States
(12) Patent Application Publication
(10) Pub. No.: US 2003/0182239 A1
(43) Pub. Date: Sep. 25, 2003

(54) System and method for providing internet services to sports enthusiasts such as tennis players

(76) Inventor: Yann O. Auzoux, Washington, DC (US)

Correspondence Address: Peter K. Skiff, BURNS, DOANE, SWECKER & MATHIS, L.L.P., P.O. Box 1404, Alexandria, VA, 22313-1404, US

(21) Appl. No.: 10/102,201

(22) Filed: Mar. 21, 2002

(51) Int. Cl. G06F 17/60

(52) U.S. Cl. 705/64; 705/67

(57) ABSTRACT

A system and method of providing internet services to sports enthusiasts such as tennis players. According to the method, an electronic communication from a tennis player is transmitted over the internet to a virtual tennis center web site which determines whether the tennis player is an authorized user of the web site. A password prompt can be displayed to allow the authorized user to obtain full access to various screens on the web site. The web site determines whether the electronic communication is an e-mail or search request and conducts a search in a searchable database if the electronic communication is a search request. Alternatively, a notification is sent to one or more authorized users of the web site if the electronic communication is an e-mail intended for the one or more authorized users or a notification is forwarded to one or more authorized business entities if the electronic communication is an e-mail inquiring about tennis goods and/or services.

### FIELD OF THE INVENTION

The invention relates to internet services which can include instant messaging technology which links consumers having a particular interest such as particular sports activities with business offering services and/or goods which relate to the particular sports interest.

### BACKGROUND OF THE INVENTION

The internet has provided opportunities for service providers to link customers and businesses for purposes of distributing content and/or merchandising activities. Also, computer users can use the internet to send emails to individuals and/or businesses or organizations. A popular e-mail service is instant messaging which notifies the computer user when an e-mail is received.

U.S. Pat. No. 6,092,053 discloses a system for merchant invoked electronic commerce allowing users to purchase items over a network and merchants to receive payment information relating to the purchases. According to the '053 patent, the system includes a server having software which gathers the purchasing information from a consumer to complete a purchasing transaction over a network. The system includes a consumer data structure that stores purchasing information for registered consumers. The software is intended to access the consumer data structure and enter the consumer's purchasing information during subsequent purchases. Thus, the consumer does not need to enter the same information every time a purchase is made over the network.

U.S. Pat. No. 6,122,632 discloses an electronic message or e-mail management system having a digital computer for accepting e-mail messages, a program interface for automatically transferring received electronic messages to a database, a structured database for storing the received electronic messages in a predetermined format, and an interface for allowing a customer service representative at a remote computer to access and respond to the electronic messages stored at the database.

U.S. Pat. No. 6,240,415 discloses a system for computerized management of a method of corporate, business or sports management by a remote party. According to the '415 patent, data of a player together with a historical database related to that player and decisions can be transmitted. The data is communicated between a central database processing resource and at least one remote party. The remote party is permitted to access the database and access designated data from the database. Voting and other management of the player, team or business is possible in substantially real time or near real time by the remote party. Thus, a remote user can vote on financial compensation for a player, a coach or a team and/or for a bonus for a player, team or game.

U.S. Pat. No. 6,338,044 discloses a system for distributing entertainment programming with embedded advertising over the internet. The entertainment programming can be customized according to consumer's stated preferences and the advertising is customized according to the consumer demographics and also according to consumer's stated preferences. A computing system is used to create and distribute personalized entertainment and advertising content. The '044 patent states that software agents are used to administer a master digital library as well as a user's digital libraries, establish advertising bookings and insert advertising content, establish schedules of digital content for distribution to end users, identify digital content listed on a schedule but missing from the end user's digital library, distribute across a communications network digital content to end users, and rescript and play or display the digital entertainment and advertising content.

While various systems have been disclosed for purposes of allowing users of computers to communicate with each other and conduct electronic transactions over the internet, there is still a need for internet-based solutions for linking individuals, especially those with common interests such as a particular sports interest, with businesses and/or organizations which provide services, goods, news or other information of interest to the user group.

### SUMMARY OF THE INVENTION

The invention provides a system and a method of providing internet services to sports enthusiasts such as tennis players, wherein an electronic device such as a computer or hand held device can be used to transmit an electronic communication from an authorized user such as a tennis player over the internet to a web site such as a virtual tennis center web site. The method includes determining whether the electronic communication has been sent from an authorized user of the web site, optionally displaying a password prompt to allow the authorized user to obtain full access to various screens on the web site, determining whether the electronic communication is an e-mail or search request, conducting a search in a searchable database if the electronic communication is a search request, forwarding a notification to one or more authorized users of the web site if the electronic communication is an e-mail intended for the one or more authorized users or forwarding a notification to one or more authorized business entities if the electronic communication is a search request inquiring about tennis goods and/or services.

The method can include transmitting an electronic business communication from an authorized business entity to the web site, determining whether the electronic business communication is an e-mail or search request, conducting a search in a searchable database if the electronic business communication is a search request or forwarding a notification to one or more authorized users of the web site if the electronic business communication is an e-mail intended for the one or more authorized users to provide information regarding tennis goods and/or services.

In accordance with a preferred embodiment, client software is downloaded onto a computer and the client software is used to access the web site and sign up a user as a registered member of the virtual tennis center. The method can include using the client software to display a screen on the computer and enter personal information and/or select one or more customized fields such as geographic location, league membership, gender, rating, ranking, equipment or the like.

In accordance with another preferred embodiment, business software is downloaded onto a computer and the business software is used to access the web site and send electronic business communications regarding lessons, court time, events, notices, news, promotions, or other information to authorized users of the web site.

With the system according to the invention, tennis players can send an electronic communication to reserve tennis court time, book a tennis lesson, purchase a ticket to a professional tennis match, become a member of a tennis organization, arrange a tennis match with another authorized user of the web site, and/or review an authorized user's tennis statistics such as match statistics, ranking, rating, league membership or the like. The tennis player can also receive a business electronic communication which relates to a discount on tennis clothes or equipment such as racquets, strings, balls, shoes, shirts, shorts, bags, or the like.

The system can be used for contacting other select user groups. For instance, the electronic communication can be directed to a select group of authorized users such as team members, tennis players within a limited geographic area, tennis players having a particular NTRP rating, tennis players available for match play during limited time frames, tennis players of a specific gender, tennis players of a limited age group, handicapped tennis players, injured tennis players, or the like. Alternatively, the electronic communication can be transmitted from the web site to an e-mail address of a tennis facility, a ticketing agent, a tennis organization, or the like.

The electronic device is preferably a computer having client software which allows the tennis player to receive instant messages forwarded from the web site or directly from other authorized users whereby instant messages can be sent to authorized users of the web site.

In utilizing the web site, the method can include displaying a host web page on the tennis player's computer screen, prompting the tennis player to input player information in one or more fields of the web page, transmitting the player information to a host server connected to the web site, storing the player information in the searchable database, and/or receiving a search request from an authorized user of the web site for player information stored in the searchable database, searching the player information stored in the searchable database, responding to the search request by transmitting requested information to the authorized user.

The preferred electronic device comprises a computer having client software and a web browser, the client software cooperating with the web browser to forward a browser identifier to the web site. However, an authorized user can access the web site from any computer linked to the internet and use the host computer to carry out authorized activities using the client software. Optionally, the client software or the web site prompts the tennis player to supply a password before transmitting the electronic communication to the web site. With the system, the electronic communication can be communicated to one on more other registered users in substantially real or near real time. In use, the electronic communication can be a request for information regarding the sale of a tennis related product or service. Alternatively, the electronic communication can be a request for information regarding tennis players, tennis centers, tennis sites, tennis venues, tennis professionals, tennis events, tennis programs, tennis camps, tennis teachers, tennis court reservations, tennis membership sign-ups, event sign-ups, or the like.

The web site preferably includes search software whereby the method can include storing tennis player information in the database by searchable fields including name, address, gender, age, ranking, rating, tennis league membership, tennis pro affiliation, tennis club affiliation, opponent list, performance statistics, and the like. As an example, the electronic communication can relate to scheduling a lesson with a tennis pro, in which case the web site reformats the electronic communication and stores reformatted information in the searchable database and sends a notification to a registered tennis pro that a lesson has been requested. In another example, the web site includes mailboxes for the authorized users of the web site and the business entity is a tennis facility, in which case the method includes sending an e-mail notification to at least some of the mailboxes of the authorized users regarding a special offer relating to availability of tennis programs, arranging tennis lessons or reserving court time. In yet another example, the web site includes mailboxes for the authorized users of the web site and the business entity is a sports goods retailer, in which case the method includes sending an e-mail notification to at least some of the mailboxes regarding a special offer relating to tennis equipment and/or tennis clothing available from the sports goods retailer.

### BRIEF DESCRIPTION OF THE DRAWINGS

FIG. 1 is a flow chart of method steps in accordance with the invention.

FIG. 2 is a flow chart of method steps in accordance with the invention.

FIG. 3 is a flow chart of method steps in accordance with the invention.

FIG. 4 is a flow chart of method steps in accordance with the invention.

FIG. 5 is a flow chart of method steps in accordance with the invention.

FIG. 6 is a flow chart of method steps in accordance with the invention.

FIG. 7 is a block diagram of a system in accordance with the invention.

FIG. 8 is a flow chart of method steps in accordance with the invention.

FIG. 9 is a flow chart of method steps in accordance with the invention.

### DETAILED DESCRIPTION OF THE PREFERRED EMBODIMENTS

The invention provides an internet solution for linking consumers having a particular interest such as sports activities with businesses and/or organizations offering goods and/or services of interest to the consumers. In the following, the invention is described with reference to consumers having tennis as their sports interest. However, the invention has applicability to other sports or entertainment such as auto racing, baseball, golf, basketball, football, hockey, soccer, horse riding, boating, bowling, cycling, figure skating, fishing, fitness, gymnastics, hunting, lacrosse, martial arts, running, scuba diving, skateboarding, snow sports including snow boarding and skiing, surfing, swimming, track and field, etc.

In practicing the invention, a user typically logs onto a computer and the computer screen displays instant messages received from players and/or businesses. The user is able to customize reception of incoming messages. For instance, the messages which appear on the user's e-mail system have preferably been screened to allow messages meeting the user's preference list are communicated to the user. The user's computer can include a client software program which allows the user to carry out various functions or the user can access the web site and carry out the same functions using the software of the host computer. The software would provide the ability to send and receive instant messages, filter incoming messages, carry out searches and store data as desired by the user.

The invention also permits business entities such as tennis instructors, sports clubs, tennis centers, retailers, wholesalers and/or organizations to communicate with the users so as to provide information regarding services, news and/or consumer goods. For example, a particular business entity could communicate a special offer such as a discount on consumer goods or available court time at an indoor or outdoor tennis facility. Likewise, tennis coaches, players and instructors could communicate their availability to give lessons and/or offer tennis programs such as individual or group lessons or information regarding upcoming tournaments, clinics, social events, and the like. The business entities are preferably provided with management software customized to provide features of interest to such businesses (e.g., membership sign up capability for organizations, court reservation capability for tennis clubs, purchase capability for retailers/wholesalers, etc.). For example, the businesses could access information from the web site and use the information for direct marketing to recreational and professional tennis players, offer ticketing for professional events, on-line booking of tennis court reservations and the like.

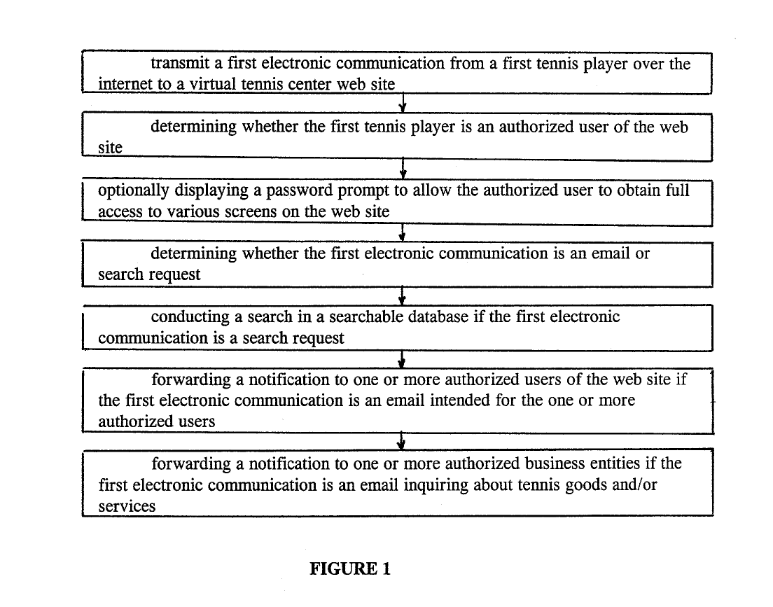

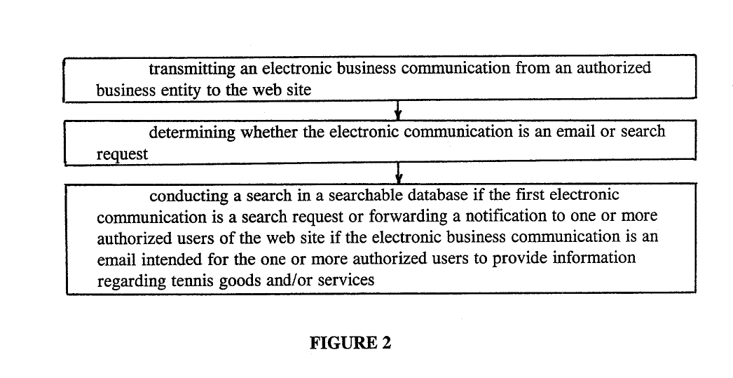

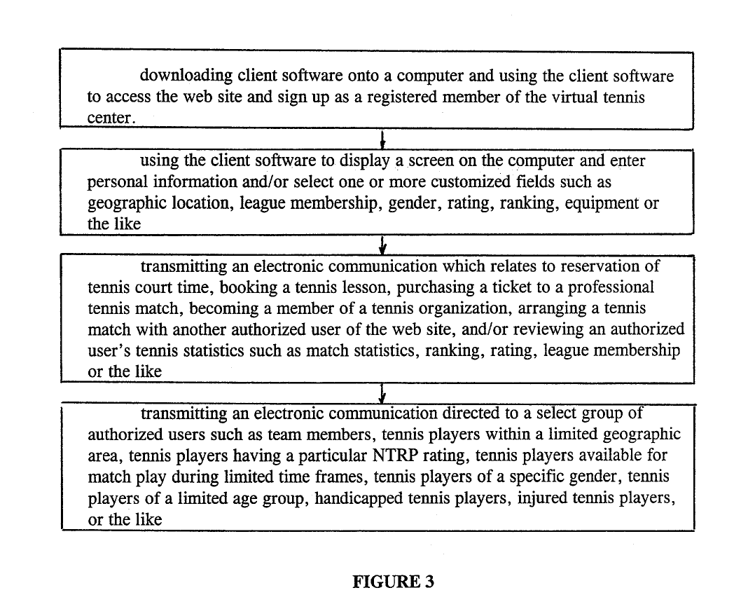

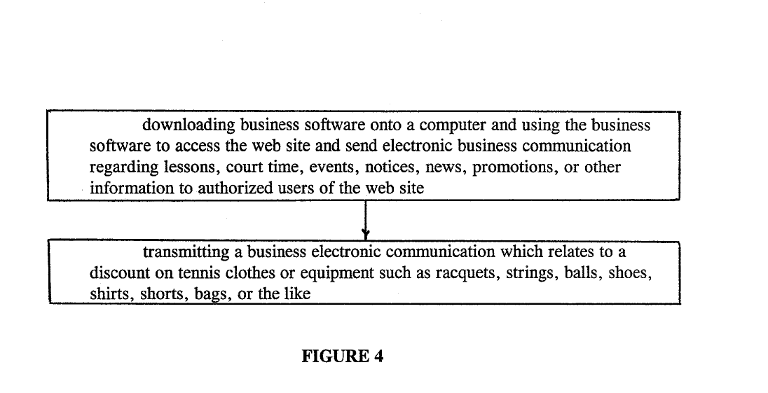

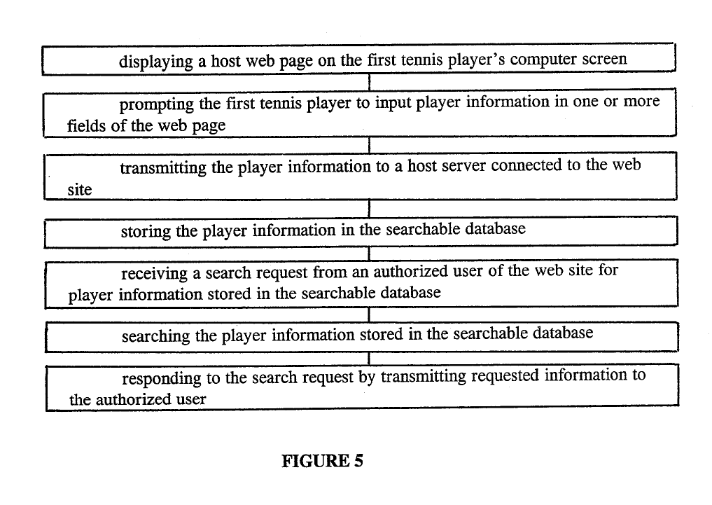

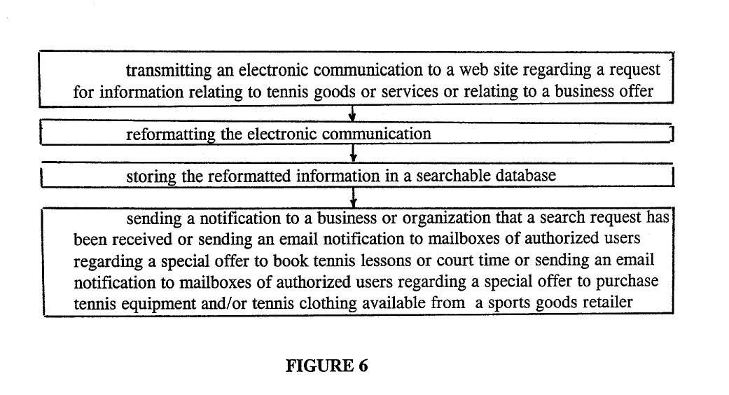

FIGS. 1-6 show flow charts of method steps in accordance with the invention. FIG. 1 shows a series of steps wherein a tennis player transmits an electronic communication to a web site and after the web site determines if the communication is an email or search request, the web site forwards the email or conducts a search of a database based on the search request. FIG. 2 illustrates how the system can be used to process a business communication wherein it is determined if the business communication is an email or search request. FIG. 3 illustrates how the system can be used to provide a user with client software so that the user can register as an authorized user, the client software providing customer preferences and allowing various functions to be carried out at the web site. FIG. 4 illustrates how business software can be downloaded onto a computer of a business entity to allow the business to carry out various functions using the web site. FIG. 5 illustrates how a tennis player might use the system to search and store information available through use of the web site. FIG. 6 illustrates how a business entity might use the web site to respond to a tennis player's request for information relating to goods and services.

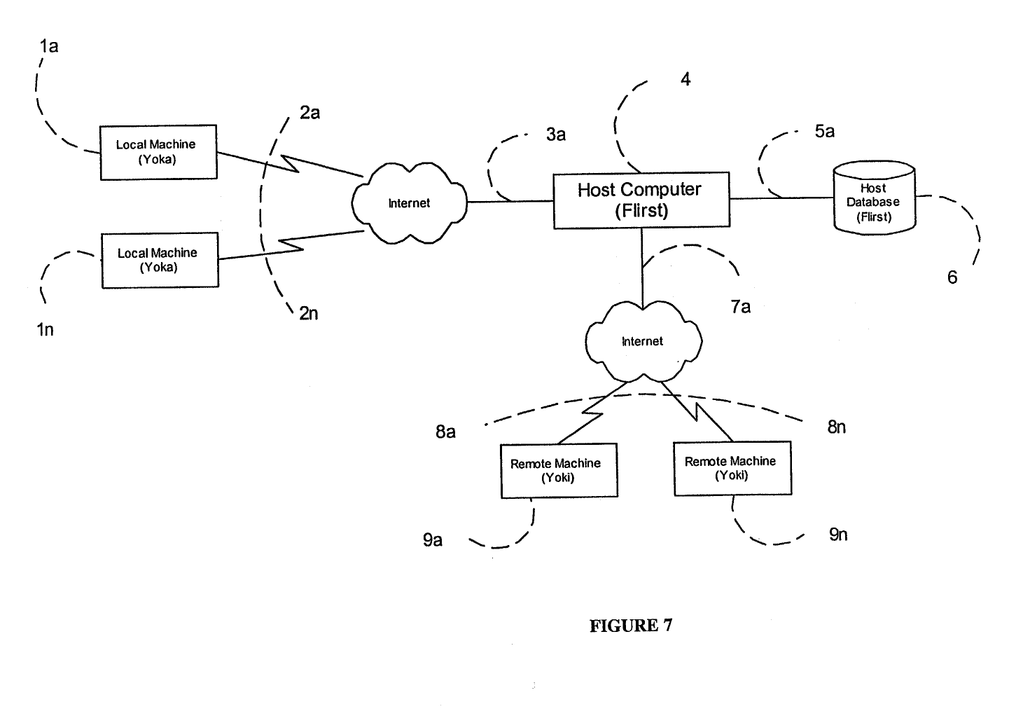

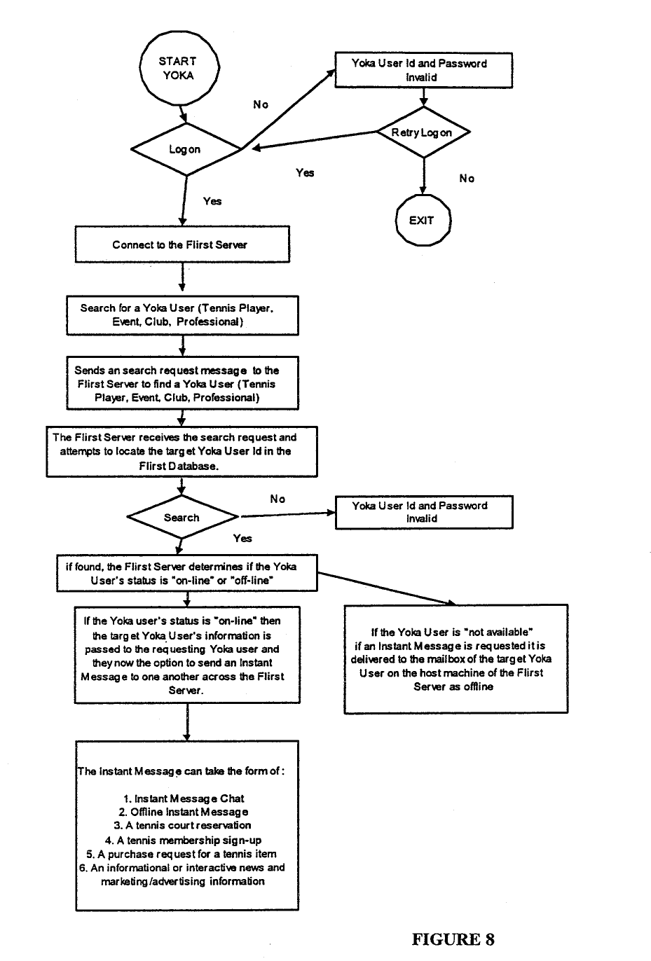

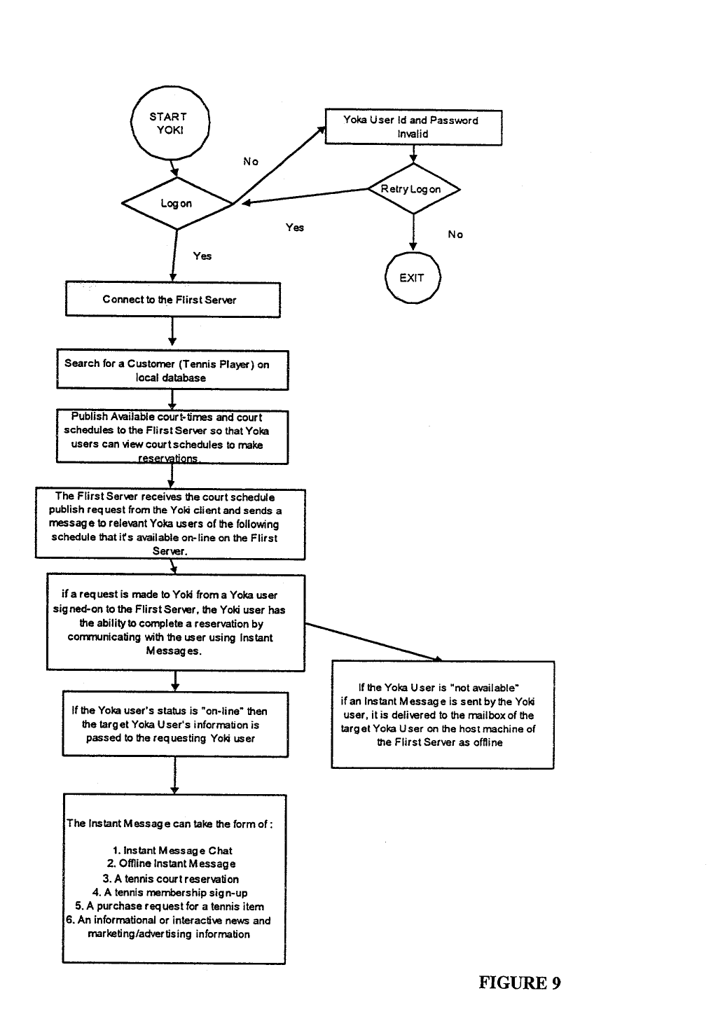

According to one embodiment of the invention, a tennis messaging system is composed of two core components—one high-level chat/messaging client component used by the players, and one low-level messaging component used by the business entities. Together both of these components communicate with a central processing system which implements the various functions of the component. FIG. 7 illustrates features of the high-level component referred to as YOKA™ and the low-component system referred to as YOKI™. Both components interact with the web site component which is referred to as FLIRS™. As shown, users access the system through local computers (YOKA™) 1a, . . . 1n and the computers are connected to the internet via lines 2a, . . . 2n such as hard wiring, wireless connections, or the like. The internet is accessible from a host computer 4 via line 3a and a host database (FLIRST™) is connected to the host computer 4 via line 5a. Business entities access the system through computers (YOKI™) 9a, . . . 9n which communicate with the internet via lines 8a, . . . 8n and the host computer communicates with the business entities' computers via line 7a. FIG. 8 illustrates steps of using YOKA™ and FIG. 9 illustrates steps of using YOKI™.

The high-level component is a sports enthusiasts' software program that provides, simplifies, and activates tennis messaging functions. The high-level component also performs additional messaging functions. Each high-level component is responsible for performing high-level messaging functions such as instant messaging, chat, message reception and submission, searching (tennis players, tennis centers/sites/venues, tennis professionals, tennis events, tennis programs/camps, tennis teachers), online tennis court reservations, tennis memberships sign-ups and event sign-ups. The high-level component is run on one or more systems including web server and database hardware components which will run on Windows® or other operating system.

The high-level component is implemented by the web server which reformats and searches data, keeps track of tennis player improvements, tennis match records, bio-rhythms, tennis player statistics and tennis tracker charts, and also stores and maintains tennis cost and spending information, such as community and activity information, tennis projection reviews and analyzes, and if desired present data in a format suitable for printing such as a player improvement statement or the like.

The high-level component collects and distributes request information received from a user. The high-level component accepts application messages (in the preferred embodiment these messages will be TCP/IP messages) and signals to the central processing unit the results of those messages. The high-level components maintain a fixed I/O buffer for outbound and inbound messages which are stored in process-local memory. Each high-level component is responsible for logging, and maintenance of diagnostic and database information.

The low-level component manages all scheduling operations for the higher-level components and detects, processes and routes communications requests received from the high-level component, and external applications to perform online reservations and fulfill search requests for finding players, centers/sites/venues, events, programs/camps, teachers, shopping, sponsors, benefits and discounts. The low-level component allows for the database storage of customers profiles, data for: vendors and affiliates, centers/sites members, teachers, programs and camps, referrals and reports, sponsors. The low-level component provides functions to perform statistical analysis on existing data stored in the database, allows for the analysis and management of business operations, revenues, and other business data.

All components within the central processing unit allow for the capability to push advertising and marketing information, and related messages to high-level and low-level client components. Typically this can occur using: e-mail marketing, instant notification marketing, banner marketing, and direct and live marketing.

The high-level and low-level components communicate via lightweight data exchange protocol containing structured and typed information, and in the preferred embodiment this will be an XML based protocol.

The host server preferably stores and manages complex logic and criteria for scheduling jobs (requests) to be carried out, it can be configured to be capable of performing any type of messaging function for integration. The central unit may maintain a number of different search algorithms to control the frequency of requests being made and thus can enact different search strategies based on the performance of individual clients (i.e., their availability). The central unit will have the ability to monitor, analyze, and report requests, client performance and utilization. The central unit will have the ability to calculate, analyze and distribute ranking information in real-time to the high-level and low-level client components. It will provide a standard web-interface for configuring content to be received or transmitted to client components. It will contain a search tool to match different tennis player profiles for a given set of criteria. It will provide algorithms and functions to conduct sweepstakes, member contests, and to maintain and provide subscriptions and membership benefits.

In accordance with the invention, business affiliates are provided a platform through which they can advertise special offers and attract business from the users of the system. Members are then provided discounts at popular businesses such as: restaurants, sports and health centers, car dealers and automotive services, retail stores, bookstore, gift shops, flower shops, etc.

While the invention has been described in detail with reference to specific embodiments thereof, it will be apparent to those skilled in the art that various changes and modifications can be made, and equivalents employed, without departing from the scope of the appended claims.

1. A method of sending electronic messages between tennis players over the internet, comprising:
using an electronic device to transmit an electronic communication from a tennis player over the internet to a virtual tennis center web site;
determining whether the tennis player is an authorized user of the web site;
optionally displaying a password prompt to allow the authorized user to obtain full access to various screens on the web site;
determining whether the electronic communication is an e-mail or search request;
conducting a search in a searchable database if the electronic communication is a search request;
forwarding a notification to one or more authorized users of the web site if the electronic communication is an e-mail intended for the one or more authorized users;
forwarding a notification to one or more authorized business entities if the electronic communication is a search request inquiring about tennis goods and/or services.

2. The method of claim 1, further comprising transmitting an electronic business communication from an authorized business entity to the web site, determining whether the electronic business communication is an e-mail or search request, conducting a search in a searchable database if the electronic business communication is a search request or forwarding a notification to one or more authorized users of the web site if the electronic business communication is an e-mail intended for the one or more authorized users to provide information regarding tennis goods and/or services.

3. The method of claim 1, further comprising downloading client software onto a computer and using the client software to access the web site and sign up as a registered member of the virtual tennis center and optionally using the client software to display a screen on the computer and enter personal information and/or select one or more customized fields such as geographic location, league membership, gender, rating, ranking, equipment or the like.

4. The method of claim 1, further comprising downloading business software onto a computer and using the business software to access the web site and send electronic business communications regarding lessons, court time, events, notices, news, promotions, or other information to authorized users of the web site, the business electronic communication preferably relating to a discount on tennis clothes or equipment such as racquets, strings, balls, shoes, shirts, shorts, bags, or the like.

5. The method of claim 1, wherein the electronic communication relates to reservation of tennis court time, booking a tennis lesson, purchasing a ticket to a professional tennis match, becoming a member of a tennis organization, arranging a tennis match with another authorized user of the web site, and/or reviewing an authorized user's tennis statistics such as match statistics, ranking, rating, league membership or the like, the electronic communication optionally being transmitted from the web site to an e-mail address of a tennis facility, a ticketing agent, a tennis organization, or the like.

6. The method of claim 1, wherein the electronic communication is directed to a select group of authorized users such as team members, tennis players within a limited geographic area, tennis players having a particular NTRP rating, tennis players available for match play during limited time frames, tennis players of a specific gender, tennis players of a limited age group, handicapped tennis players, injured tennis players, or the like.

7. The method of claim 1, further comprising transmitting the electronic communication from an electronic device having client software which allows the tennis player to receive instant messages from the web site, the method including receiving the instant messages from the web site and/or from other authorized users of the web site.

8. The method of claim 7, wherein the electronic device comprises a computer, the method including displaying a host web page on the tennis player's computer screen, prompting the tennis player to input player information in one or more fields of the web page, transmitting the player information to a host server connected to the web site, storing the player information in the searchable database, receiving a search request from an authorized user of the web site for player information stored in the searchable database, searching the player information stored in the searchable database, responding to the search request by transmitting requested information to the authorized user.

9. The method of claim 1, further comprising transmitting the electronic communication from a computer having client software and a web browser, the client software cooperating with the web browser to forward a browser identifier to the web site.

10. The method of claim 1, wherein the web site prompts the tennis player to supply a password before sending the electronic communication to the web site or the electronic communication is communicated to one on more other registered users in substantially real or near real time, or the electronic communication is a request for information regarding the sale of a tennis related product or service.

11. The method of claim 1, wherein the electronic communication is a request for information regarding tennis players, tennis centers, tennis sites, tennis venues, tennis professionals, tennis events, tennis programs, tennis camps, tennis teachers, tennis court reservations, tennis membership sign-ups, event sign-ups, or the like.

12. The method of claim 1, wherein the web site includes search software and the method includes storing tennis player information in the database by searchable fields including name, address, gender, age, ranking, rating, tennis league membership, tennis pro affiliation, tennis club affiliation, opponent list, performance statistics, and the like.

13. The method of claim 1, wherein the electronic communication relates to scheduling a lesson with a tennis pro, the web site reformats the electronic communication and stores reformatted information in the searchable database and sends a notification to a registered tennis pro that a lesson has been requested or the web site includes mailboxes for the authorized users of the web site and the business entity is a tennis facility, the method including sending a search request notification to at least some of the mailboxes of the authorized users regarding a special offer to book tennis lessons or court time.

14. The method of claim 1, wherein the web site includes mailboxes for the authorized users of the web site and the business entity is a sports goods retailer, the method including sending an e-mail notification to at least some of the mailboxes regarding a special offer to purchase tennis equipment and/or tennis clothing available from the sports goods retailer.

15. A method of providing internet services to sports enthusiasts such as tennis players, comprising:
receiving an electronic communication from a sports enthusiast such as a tennis player, the electronic communication being directed to a web site offering internet services to authorized users of the web site;
determining whether the sports enthusiast is an authorized user of the web site;
optionally displaying a password prompt to allow the authorized user to obtain full access to various screens on the web site;
determining whether the electronic communication is an e-mail or search request;
conducting a search in a searchable database if the electronic communication is a search request;
forwarding a notification to one or more authorized users of the web site if the electronic communication is an e-mail intended for the one or more authorized users;
forwarding a notification to one or more authorized business entities if the electronic communication is a search request inquiring about goods and/or services such as tennis related goods or services.

16. The method of claim 15, further comprising determining if one or more authorized users are connected to the internet and forwarding the electronic communication to at least one of the online authorized users if the electronic communication is an e-mail intended for any of the online authorized users.

17. A system for providing internet services to sports enthusiasts such as tennis players, comprising:
a web server adapted to receive an electronic communication from a sports enthusiast such as a tennis player, the electronic communication being directed to a web site offering internet services to authorized users of the web site;
a software program adapted to determine whether the sports enthusiast is an authorized user of the web site and optionally display a password prompt to allow the authorized user to obtain full access to various screens on the web site;
the software program being further adapted to determine whether the electronic communication is an e-mail or search request and conduct a search in a searchable database if the electronic communication is a search request or forward a notification to one or more authorized users of the web site if the electronic communication is an e-mail intended for the one or more authorized users or forward a notification to one or more authorized business entities if the electronic communication is a search request or email inquiring about goods and/or services such as tennis related goods or services.

18. The system of claim 17, wherein the software program is further adapted to determine if one or more authorized users are connected to the internet and forward the electronic communication to at least one of the online authorized users if the electronic communication is an e-mail intended for any of the online authorized users.

19. The system of claim 18, further comprising a business software program adapted to transmit an electronic business communication from an authorized business entity to the web site, the web site program being adapted to determine whether the electronic business communication is an e-mail or search request, conduct a search in a searchable database if the electronic business communication is a search request or forward a notification to one or more authorized users of the web site if the electronic business communication is an email intended for the one or more authorized users to provide information regarding tennis goods and/or services, the business software being adapted to permit an authorized business entity to access the web site and send electronic business communications regarding lessons, court time, events, notices, news, promotions, or other information to authorized users of the web site, the business electronic communication preferably relating to a discount on tennis clothes or equipment such as racquets, strings, balls, shoes, shirts, shorts, bags, or the like.

20. The system of claim 18, further comprising client software adapted to allow an authorized user to access the web site and sign up as a registered member of the virtual tennis center, the client software optionally being adapted to display a screen on a computer being used by the authorized user and allow the authorized user to enter personal information such as geographic location, league membership, gender, rating, ranking, equipment or the like to be stored on the web site and/or set preferences which screen incoming email.

21. A computer-readable medium containing a program that executes the following steps:
determining whether a received electronic communication is an e-mail or search request;
conducting a search in a searchable database if the electronic communication is a search request;
forwarding a notification to one or more authorized users of the web site if the electronic communication is an e-mail intended for the one or more authorized users;
forwarding a notification to one or more authorized business entities if the electronic communication is a search request inquiring about goods and/or services such as tennis related goods or services.
